(19) United States
(12) Patent Application Publication
(10) Pub. No.: US 2022/0365813 A1
(43) Pub. Date: Nov. 17, 2022

(54) Apparatus, Device, Method, and Computer Program for Scheduling an Execution of Compute Kernels

(71) Applicants: Rajesh POORNACHANDRAN, PORTLAND, OR (US); Ben J. ASHBAUGH, Folsom, CA (US); Gregory LUECK, North Chelmsford, MA (US); James BRODMAN, Marlborough, MA (US); Simon PENNYCOOK, San Jose, CA (US); Michael KINSNER, Halifax (CA); Roland SCHULZ, Portland, OR (US)

(72) Inventors: Rajesh POORNACHANDRAN, PORTLAND, OR (US); Ben J. ASHBAUGH, Folsom, CA (US); Gregory LUECK, North Chelmsford, MA (US); James BRODMAN, Marlborough, MA (US); Simon PENNYCOOK, San Jose, CA (US); Michael KINSNER, Halifax (CA); Roland SCHULZ, Portland, OR (US)

(21) Appl. No.: 17/809,291

(22) Filed: Jun. 28, 2022

(51) Int. Cl. G06F 9/48

(52) U.S. Cl. CPC G06F 9/4881

(57) ABSTRACT

Examples relate to an apparatus, a device, a method, and a computer program for scheduling an execution of compute kernels on one or more computing devices, and to a computer system comprising such an apparatus or device. The apparatus comprises processing circuitry and interface circuitry. The processing circuitry is configured to determine an impending execution of two or more compute kernels to the one or more computing devices. The processing circuitry is configured to pipeline a data transfer related to the execution of the two or more compute kernels to the one or more computing devices via the interface circuitry.

### FIELD

Examples relate to an apparatus, a device, a method, and a computer program for scheduling an execution of compute kernels on one or more computing devices, and to a computer system comprising such an apparatus or device.

### BACKGROUND

With the increasing diversity and number of heterogeneous accelerator devices (XPUs, X Processing Units, with X representing a diverse range of accelerator devices) deployed in systems, including XPUs that may themselves be composite devices with multiple tiles or compute elements, optimization of data movement and compute invocation latencies is increasingly important for system-level optimization. Many approaches regarding data movement and compute invocation are primarily based around eager execution or lazy batching. In general, compute tasks scheduling and data movement across one or more accelerator devices are performed without considering any temporal or spatial relationship. This may result in less than efficient placement and mapping of compute kernels to heterogeneous accelerators, and thus suboptimal latency, aggregate throughput, or power performance. Inefficient data movement may result in memory thrash and data shuffle, which may degrade latency, jitter, and power consumption metrics.

### BRIEF DESCRIPTION OF THE FIGURES

Some examples of apparatuses and/or methods will be described in the following by way of example only, and with reference to the accompanying figures, in which:

FIG. 1a shows a block diagram of an example of an apparatus or device for scheduling an execution of compute kernels on one or more computing devices;

FIG. 1b shows a block diagram of an example of a computer system comprising an apparatus or device for scheduling an execution of compute kernels on one or more computing devices;

FIG. 1c shows a flow chart of an example of a method for scheduling an execution of compute kernels on one or more computing devices;

FIG. 2 shows a block diagram of an example of two computer systems, with one of the computer systems comprising an apparatus or device for scheduling an execution of compute kernels on one or more computing devices, and at least the other computer system comprising one or more computing devices;

FIG. 3 shows an example of a scheduling of two kernels and associated data transfers; and

FIG. 4 shows an example of a scheduling of pipelining of data transfers associated with a single kernel.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Various examples of the present disclosure relate to a concept for cooperative full and partial data movement and kernel invocation pipelining for accelerator latency, throughput, and power optimization.

The present disclosure relates to a concept for pipelining optimizations for batches of data transfers and kernel invocations, which may enhance system level performance, in terms of latency, throughput and power metrics, which may be considered critical as the industry increasingly adopts accelerator-based computing. These improvements or optimizations may be employed on systems containing heterogeneous or homogeneous collections of accelerators (in the following denoted “computing devices”), and also on systems containing accelerators that are internally composed of computational tiles (such as Intel® GPUs) or similar decompositions. Combined with increasing data center and edge power supply and cooling challenges, the described pipelining improvements or optimizations may leverage information from both compilation and runtime systems to provide an automatic improvement or optimization of workloads. The provided concept may be considered non-obvious in that it opposes the scheduling approaches that are increasingly adopted in accelerator data movement and execution scheduling systems.

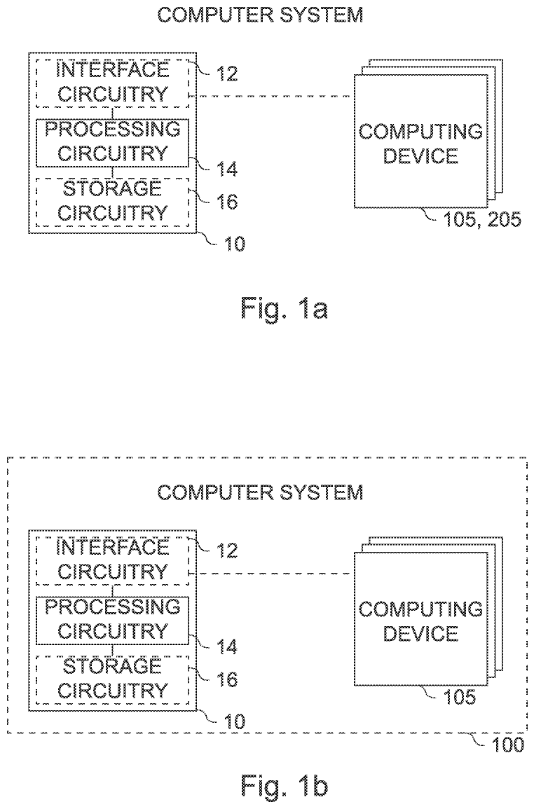

FIG. 1a shows a block diagram of an example of an apparatus 10 or device 10 for scheduling an execution of compute kernels on one or more computing devices 105; 205. The apparatus 10 comprises circuitry that is configured to provide the functionality of the apparatus 10. For example, the apparatus 10 of FIGS. 1a and 1b comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus, in conjunction with the interface circuitry 12 (for exchanging information, e.g., with other components of the computer system or outside the computer system, such as the one or more computing devices 105; 205 and/or another computer system 200) and the storage circuitry (for storing information, such as machine-readable instructions) 16. Likewise, the device 10 may comprise means that is/are configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is configured to determine an impending execution of two or more compute kernels to the one or more computing devices. The processing circuitry 14 or means for processing 14 is configured to pipeline a data transfer related to the execution of the two or more compute kernels to the one or more computing devices via the interface circuitry 12 or means for communicating 12.

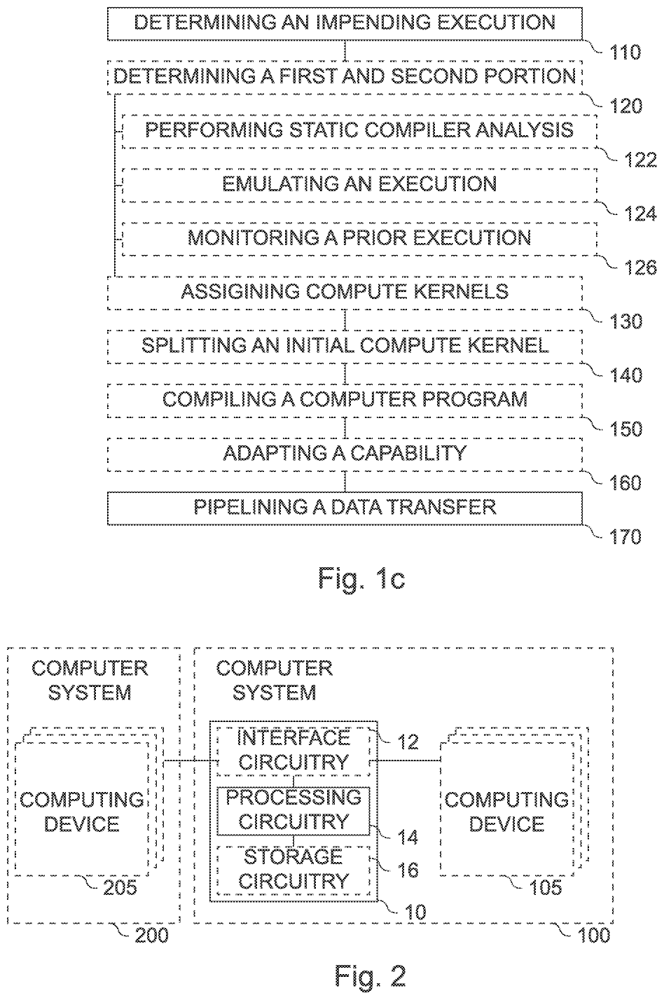

FIG. 1b shows a block diagram of an example of a computer system 100 comprising the apparatus 10 or device 10 for scheduling the execution of compute kernels on the one or more computing devices 105. For example, as shown in FIG. 1b, the computer system 100 may comprise the one or more computing devices 105, e.g., a subset of the one or more computing devices. As will be illustrated in connection with FIG. 2, the computer system 100 may comprise the apparatus 10 and optionally one or more computing devices 105, and another computer system 200 may comprise one or more computing devices 205 (e.g., without requiring an apparatus 10 or device 10 being present as part of the computer system 200).

FIG. 1c shows a flow chart of an example of a corresponding method for scheduling the execution of compute kernels on the one or more computing devices. The method comprises determining 110 an impending execution of two or more compute kernels to the one or more computing devices. The method comprises pipelining 170 a data transfer related to the execution of the two or more compute kernels to the one or more computing devices.

In the following, the functionality of the apparatus 10, the device 10, the method and of a corresponding computer program is illustrated with respect to the apparatus 10. Features introduced in connection with the apparatus 10 may likewise be included in the corresponding device 10, method and computer program.

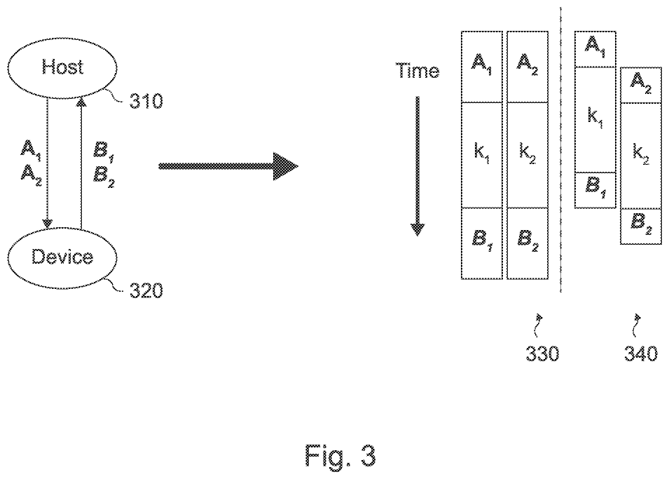

Various examples of the present disclosure are based on the insight, that a scheduling of an execution of compute kernels without considering the temporal and spatial relationship between the compute kernels being invoked and computing devices being used can lead to substantial delays or other inefficiencies. For example, due to limited throughput of an interconnect between the host CPU (Central Processing Unit, which may be the processing circuitry 14) and the computing device, the transfer of data related to the execution (in particular input data, but also output data) may delay the execution of the compute kernel. For example, as shown in FIG. 3, if the input data A₁, A₂ of both kernels k₁, k₂ is transferred at the same time via the same interconnect link (i.e., communication link) as part of the first possible ordering 330, both data transfers are completed later, which leads to a delay in the execution of both kernels. If one of the data transfers (in this case A₂ in the second possible ordering 340) is delayed, the other data transfer A₁ is completed earlier, so that the respective kernel k₁ is executed earlier, and thus the aforementioned delay is eliminated. In other words, the processing circuitry may be configured to pipeline the data transfer to the one or more computing devices such, that a concurrent data transfer of data related to the two or more compute kernels is avoided (this includes data transfer of output data). For a given interconnect link (e.g., PCIe (Peripheral Component Interconnect express) or CXL (Compute Express Link)) between the host processor (e.g., the processing circuitry 14 of the computer system 100) and one or more accelerators (e.g., the one or more computing devices 105), transfer of data required for individual units of compute (i.e., compute kernels) and the invocation of those units of compute are pipelined (i.e., temporally staggered). The proposed concept is particularly relevant if data is to be transferred via the same communication link. The exact implementation of the timelining, i.e., which portion of data associated with which kernel is transferred when, depends on the memory access pattern of the kernel, but also on the capabilities of the interconnect/communication link. Consequently, the processing circuitry may be configured to pipeline the data transfer based on a data communication bandwidth available for transferring the two or more compute kernels.

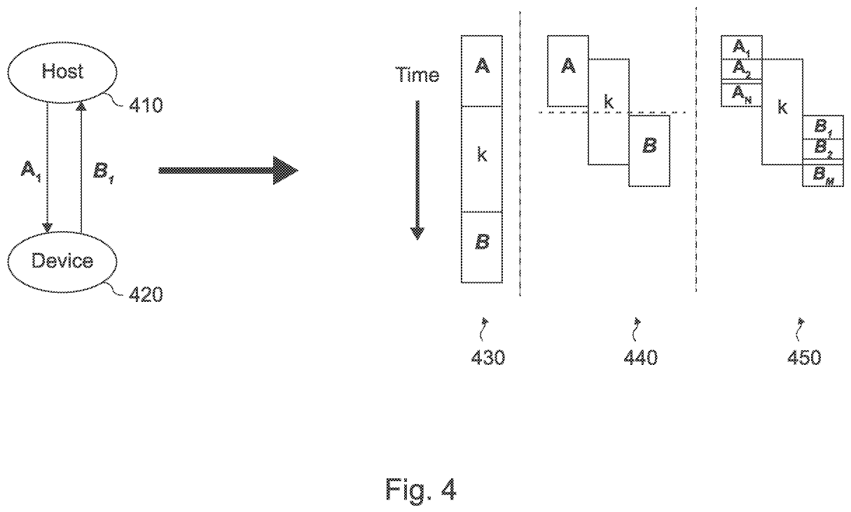

The pipelining may be based on treating multiple kernel invocations as a system-scope optimization problem (a first approach, as shown in FIG. 3) and/or based around decomposition of the work of a kernel into finer grained units than an aggregate kernel invocation (a second approach, as shown in FIG. 4, orchestrated for example by a communications library such as MPI (Message Passing Interface). Pipelining enables an improvement or optimization of data transfers and invocation of specific kernels such as the second possible ordering 340 in FIG. 3, as opposed to the natural queueing of all transfers equally such as the first possible ordering 330 in FIG. 3. Such pipelining may extend to any number of data transfers and kernel invocation that share a common data transport mechanism.

Opportunities for improvement or optimization can be increased by decomposing the data for a unit of compute below the developer-provided granularity (i.e., the second approach). In the second approach, which may be combined with the first approach, the data transfer may be sub-divided into a first portion and a second portion, such that execution of compute kernels can be initiated before the input data set has been fully transferred, and/or such that the transfer of output data is initiated before the compute kernel has finished executing. In general, the execution of the two or more compute kernels may depend on the data transfer, and in particular the transfer of input data. For example, the two or more compute kernels may comprise a first compute kernel and at least one second compute kernels. The processing circuitry may be configured to pipeline the data transfer such, that the execution of the at least one second compute kernel of the two or more compute kernels and associated data is delayed until at least a portion of the data transfer related to the first compute kernel required for starting execution of the first compute kernel is completed. This may be done by sub-dividing the data transfer (e.g., of the input data) into a first and a second portion, with the first portion being required at the start of execution of the respective compute kernel, and the second portion being required at a later point in time. In other words, the processing circuitry may be configured to determine, at least for a first compute kernel, a first portion of the data transfer required for starting execution of the first compute kernel and a second portion of the data transfer used after the execution of the first compute kernel is started. Accordingly, as further shown in FIG. 1c, the method may comprise determining 120, at least for the first compute kernel, the first portion of the data transfer required for starting execution of the first compute kernel and the second portion of the data transfer used after the execution of the first compute kernel is started. The data transfer may then be pipelined such, that the data transfer related to at least one second compute kernel is delayed until the data transfer of the first portion is completed. An illustrative example of this approach is shown in FIG. 4. As shown in the second and third possible orderings 440; 450, execution of the compute kernel k is started before the transfer of the input data A is complete. Similarly, transfer of the output data B may be started before execution of the kernel k is completed (if feasible).

In some examples, the mechanisms shown in FIGS. 3 and 4 may be combined. In this case, the data transfers may be interleaved, e.g., first the first portions of the two compute kernels may be transferred successively (i.e., the first portion of the second compute kernel after the first portion of the first compute kernel), followed by the second portions of the two compute kernels. For example, the second portion of the first compute kernel may be transmitted after the first portion of the second compute kernel, and the second portion of the second compute kernel may be transmitted after the second portion of the first compute kernel. In other words, the processing circuitry may be configured to pipeline the data transfer such, that the first portion of the data transfer related to the second compute kernel is started before the data transfer of the second portion of the data transfer related to the first compute kernel is started.

In many examples outlined in the present disclosure, the pipelining is being performed with the objective of reducing a time to execution of at least one of the two or more compute kernels. However, the proposed concept is not limited to this objective. For example, the objective of reducing the time to execution may be used together with other objectives, or one or more other objectives may be used without taking into account the time to execution. For example, the data transfer may be pipelined with the objective of reducing a power consumption or reducing a thermal impact of the execution of the two or more compute kernels or the data transfer, with the objective of balancing or increasing a utilization of the computing devices, and/or with the objective of increasing a data processing throughput of the two or more compute kernels.

In the present disclosure, some examples are given on how to achieve the above-mentioned objectives. In a nutshell, the objective of reducing the time to execution can be reached by avoiding parallel data transfers (so that one of the data transfers is completed earlier, which reduces the time to execution of the associated compute kernel), and/or by splitting the data transfer into the first portion required for starting the execution and the second portion being used at a later point in time and starting the execution once the first portion is transferred. The other objectives mentioned above follow similar patterns. For example, the power or thermal-impact-related objectives may be achieved by avoiding idle times in the use of the computing devices and/or by making use of the most power- or thermally efficient computing device (thus avoiding assigning work to less power-efficient computing devices, which may also affect the pipelining). The objective of balancing or increasing the utilization of the computing devices may be achieved by pipelining the data such, that idling is avoided and/or such that the different computing devices are equally used to executing the compute kernels. For example, the objective of increasing the data processing throughput may be achieved by increasing the utilization of the computing devices and/or by reducing the time to execution.

The mechanism of splitting the data transfer into the first portion required for starting the execution and the second portion being used at a later point in time and starting the execution once the first portion is transferred can be enabled through threshold points identified within data sets (which may define the first and second portion), which are proven (or at least assumed) to be functionally safe triggers at which to overlap logically serial actions, with consideration of bus data transfer rates and kernel clock/processing rates. The threshold points (and thus the first and second portion) may be identified through any of the following approaches. For example, the threshold points may be identified through static compiler analysis of kernel memory access patterns and processing capability of the target device for the kernel(s) being compiled. In other words, the processing circuitry may be configured to determine the first and second portion of the data transfer by performing static compiler analysis of the compute kernel. Accordingly, the method may comprise determining 120 the first and second portion of the data transfer by performing 122 static compiler analysis of the compute kernel. Through static compiler analysis, a memory access pattern of the compute kernel can be determined. In other words, the static compiler analysis relates to memory access patterns. The memory access pattern may indicate the first portion of the data transfer required for starting execution of the compute kernel (e.g., input data being used in a first iteration of the compute kernel), and the second portion of the data transfer used after execution of the compute kernel has been started (e.g., input data being accessed in successive iterations of the compute kernel). How much data can be delayed depends on how long the computing device takes to execute the compute kernel combined with the memory access pattern—the faster the input data is being processed, or the more data access is spread across a large range of memory, the larger the first portion needs to be (as the compute kernel would quickly run out of input data to transfer). Accordingly, the static compiler analysis may also relate to a processing capability of the one or more computing devices the compute kernel is being compiled for, which may indicate the amount of input data required for starting execution (and not instantly running out of input data to process).

Additionally, or alternatively, the threshold points may be identified using dynamic telemetry gathering from initial warm up iteration(s), or a priori execution of an application. Additionally, or alternatively, the threshold points may be identified using dynamic telemetry gathering from in situ execution of the application, allowing for adaptive optimization as executions occur. For example, the processing circuitry may be configured to execute the two or more compute kernels, e.g., using the one or more computing devices, using the host CPU (and thus emulating the execution of the respective compute kernels), and to determine the first and second portion based on the execution. If the execution is to be performed in site (thus performing a monitoring of the execution or of warm up operations), the one or more computing devices may be used. For example, the processing circuitry may be configured to determine the first and second portion based on a monitoring of a prior execution (or current execution) of the respective compute kernel by the one or more computing devices. Accordingly, the method may comprise determining 120 the first and second portion based on a monitoring 126 of a prior execution (or current execution) of the respective compute kernel by the one or more computing devices. Alternatively, the host CPU may be used. For example, the processing circuitry may be configured to emulate the execution of the compute kernel, and to determine the first and second portion based on memory accesses occurring during the emulation. Accordingly, the method comprises emulating 124 the execution of the compute kernel and determining 120 the first and second portion based on memory accesses occurring during the emulation.

Additionally, or alternatively, the threshold points may be identified using user-provided tuning directives. These tuning directives may be included in the source code of a computer program specifying the two or more compute kernels, or they may be supplied alongside the computer program or the compute kernels. In both cases, the processing circuitry may be configured to determine the first and second portion based on user-specified information on the use of the data, such as the tuning directives.

Additionally, or alternatively, the threshold points may be identified using simple heuristics. For example, the processing circuitry may be configured to determine the first and second portion using heuristics regarding the location of the first portion within the data transfer. For example, the first few kernel invocations are likely to access the first few pages of a given memory allocation, therefore it will frequently be beneficial to begin scheduling kernel execution before the entire allocation has been transferred. In this case, the first portion of the data transfer may comprise the first few pages of the memory allocation (e.g., a pre-defined number of pages staring from the beginning of the memory allocation)

In case the determination of the first and second portion of the data transfer is unsuccessful or imprecise (i.e., the compute kernel is executed and requires data that is hitherto not transferred), a page fault mechanism may be used to delay further execution of the compute kernel until the respective data is available.

In the previous examples, the focus has been on the input data required for starting execution of the respective compute kernels. However, the same or similar approaches may be taken for handling data transfer of output data of the compute kernels, and for combination of simultaneous input and output data transfers. In particular, the data transfers of output kernels may be pipelined as well (i.e., temporarily staggered), and a parallel transfer of the output data (with other output data, or with input data of the compute kernels may be avoided). Ideally, the pipelining may be performed such, that a latency for a further processing of the output data is reduced, which includes reducing the time required for starting execution of the compute kernels and reducing the time required for transferring the output data back to the host CPU.

The proposed concept may improve communication link and memory access efficiency by avoiding interleaving or sharing of bandwidth across the transfer of multiple buffers concurrently. This is particularly relevant because startup latencies of compute kernels are often data transfer-bound, in the common case where input data must be moved (i.e., transferred) from the host or another device to the device that will execute the kernel. Intelligent batching and pipelining of data transfers and executions of portions of the compute tasks not only reduces startup and other latencies but can allow for higher efficiency of memory systems by generating direct streaming accesses, without interleaved/strided accesses from parallel direct memory access (DMA) engines which can reduce efficiency metrics, or without otherwise over-subscribing a limited number of DMA engines. For example, the DMA engine(s) of the computer system 100 may be employed for performing the actual data transfers.

In some examples, single kernel invocations may be automatically decomposed into multiple compute invocations across non-overlapping compute resources, such as compute tiles within a device, based on e.g., user-managed execution hierarchy such as workgroups within the SYCL/OpenCL execution models, or automatically though static compiler analysis and provably safe kernel fission/fracturing. In other words, existing compute kernels may be split (i.e., decomposed) into multiple smaller compute kernels to be executed (concurrently) by different computing devices or different compute circuitry (i.e., compute tiles, compute units) of the same computing device. For example, the processing circuitry may be configured to split an initial compute kernel to generate the two or more compute kernels, e.g., based on the afore-mentioned user-managed execution hierarchy such as workgroups within the SYCL/OpenCL execution models, or automatically though static compiler analysis and provably safe kernel fission/fracturing. Accordingly, as further shown in FIG. 1c, the method may comprise splitting 140 an initial compute kernel to generate the two or more compute kernels. The decomposed kernel can then leverage the pipelining techniques introduced above to realize compute with lower latency, and to balance data transfer bandwidths and memory efficiencies.

The proposed concept applies to both explicit (developer-expressed) scaling and implicit (automatic) scaling of compute kernels and applications. In the explicit scaling case where a user has expressed multiple units of compute as multiple invocations (e.g., multiple kernel enqueues in OpenCL), the pipelining improvement or optimization may initially use a greedy scheduling of all data transfers that are prerequisites for a specific kernel launch, regardless of other enqueued work which could be safely scheduled concurrently with the prioritized kernel. In other words, the processing circuitry may be configured to determine the impending execution of the two or more compute kernels to the one or more computing devices based on a user-specified invocation of the two or more compute kernels.

In the implicit scaling case where there is automatic decomposition of a single kernel from the developer perspective, the OpenCL/SYCL/Level Zero runtime and/or driver may decide on the ordering of compute unit work to greedily prioritize data transfers. Accordingly, the processing circuitry may be configured to determine the impending execution of the two or more compute kernels based on a user-specified invocation of the initial compute kernel, with the impending execution of the two or more compute kernels being derived from the user-specified invocation of the initial compute kernel. The processing circuitry may be configured to determine the ordering between the two or more compute kernels to greedily prioritize data transfers. The driver or runtime may avoid parallelizing transfers absent the ability to prove that there would be no reduction in transfer efficiency or compute unit startup latency. Mixtures of greedy and parallel scheduling can be used, with improvements or optimization performed through a runtime scheduler objective function which models the bandwidths of the available data transfer mechanisms, as well as memory efficiencies for streaming access patterns and expected kernel compute latencies.

A first level of implementation of the proposed concept may be software-based, including runtime libraries and/or operating system driver software and/or kernel compiler(s). Accordingly, the proposed functionality may be provided by a runtime environment. The processing circuitry may be configured to provide the runtime environment for executing the two or more compute kernels using the one or more computing devices, with the runtime environment performing the determination of the impending execution and the pipelining of the data transfer. Similarly, the method may comprise providing the runtime environment. Alternatively, a driver may be tasked with performing the proposed tasks. The processing circuitry may be configured to host a driver for accessing the one or more computing devices, with the driver performing the determination of the impending execution and the pipelining of the data transfer. Accordingly, the method may comprise hosting the driver.

As a third software-based option, the pipelining may be considered during compilation. In other words, the pipelined transfer may be specified as part of a computer program comprising the two or more compute kernels. The processing circuitry may be configured to compile the computer program comprising the two or more compute kernels, with the compilation being based on the pipelining of the data transfer. Accordingly, the method comprises compiling 150 a computer program comprising the two or more compute kernels, with the compilation being based on the pipelining of the data transfer. For example, the transfer of portions of the respective data transfers may be programmed to be temporally staggered (e.g., by starting the data transfer of at least a portion of the data after completion of another portion), to enforce the pipelined data transfer.

Additional improvements or optimizations become possible with hardware support, particularly when the hardware queuing and scheduling mechanisms have multiple tenant or multiple host process visibility into the cross-system actions being requested. In other words, the processing circuitry may be configured to use a hardware queuing mechanism of a computer system hosting the apparatus to pipeline the data transfer. The hardware mechanisms may provide cross-user/cross-tenant optimization of DMA invocations and kernel launches, to improve kernel launch latencies and data bus and memory efficiencies.

In some examples, e.g., using XuCode (a variant of 64-bit mode code, running from protected system memory, using a special execution mode of the CPU) with/without the knowledge of the affinity set by the operating system, the proposed art can perform smart kernel mapping based on the data & workflow at a sub-OP (operation) level, overriding NUMA (Non-Uniform Memory Architecture) affinity to maintain system wide utilization, power & thermal constraints. Accordingly, not only the pipelining may be performed by the proposed entities, but also the assignment of the compute kernels (or portions thereof) to the one or more computing devices. For example, the processing circuitry may be configured to assign the two or more compute kernels to respective compute circuitry of the one or more computing devices, and to pipeline the data transfer of the two or more compute kernels to the respective computing device based on the assignment. Accordingly, as further shown in FIG. 1c, the method may comprise assigning 130 the two or more compute kernels to respective compute circuitry of the one or more computing devices and pipelining the data transfer of the two or more compute kernels to the respective computing device based on the assignment. This assignment may be combined with, or based on, the splitting operation introduced above, e.g., to split the initial compute kernel into smaller chunks that can be assigned to different computing devices. For example, as outlined above, the assignment may maintain system wide time to execution, throughput, utilization, power and/or thermal constraints. In other words, the assignment may be performed based on at least one of a constraint with respect to a time to execution, a throughput constraint, a utilization constraint, a power consumption constraint, and a thermal constraint.

As outlined above, one of the reasons for a pipelined data transfer is the limitation of the hardware with respect to the hardware—in general, both the memory system and the interconnect may be bottlenecks during the data transfer. In some examples, the performance of said memory system and/or interconnect may be scaled up or down (e.g., using more aggressive timings). In effect, the processing circuitry may be configured to adapt at least one of a capability of at least one interconnect and a capability of at least one memory system being involved in the execution and/or data transfer based on the pipelined data transfer. Accordingly, as further shown in FIG. 1c, the method may comprise adapting 160 at least one of the capability of the at least one interconnect and the capability of the at least one memory system being involved in the execution and/or data transfer based on the pipelined data transfer. For example, based on the memory, kernel placement and prioritization, appropriate memory calibration tuning can be done to scale up/down the associated memory & interconnect (e.g., MRC (Memory Reference Code) Training or I/O (Input/Output) links) for the current scope of task graph & data flow.

In the previous examples, it was assumed that the computer system 100 comprises the apparatus 10 or device 10 and one or more computing devices 105 (e.g., a single computing device 105). Accordingly, the processing circuitry may be configured to determine the impending execution of the two or more compute kernels to a single computing device, so that the two or more compute kernels are executed by the single computing device, and to pipeline the data transfer of the two or more compute kernels to the single computing device.

However, the proposed improvements or optimizations may be extended beyond a single device, to multiple devices (homogeneous or heterogeneous) in a host-based system. In other words, the processing circuitry may be configured to determine the impending execution of the two or more compute kernels to two or more computing devices of a single computer system (i.e., the computer system 100), so that the two or more compute kernels are executed by the two or more computing devices, and to pipeline the data transfer of the two or more compute kernels to the two or more computing devices.

Further, the proposed improvements or optimizations may be extended beyond a single host-based system, to multiple nodes connected through links including (but not limited to) Ethernet and/or InfiniBand. Accordingly, the interface circuitry may be configured to communicate via Ethernet or InfiniBand. This scenario is shown in FIG. 2. In this case, the processing circuitry may be configured to determine the impending execution of the two or more compute kernels to two or more computing devices (computing device 105 of computer system 100 and computing device 205 of computer system 200 shown in FIG. 2) of two or more computer systems (i.e., computer system 100 and computer system 200 shown in FIG. 2), so that the two or more compute kernels are executed by the two or more computing devices, and to pipeline the data transfer of the two or more compute kernels to the two or more computing devices. Such implementations may underlie a multi-node system-level application written in SYCL, OpenCL and/or MPI.

Providing an improved balance of data movement decisions (which data to move, when to move it, and which movements/compute tasks to parallelize) is significant both with single and multiple accelerator devices. When portions of an application are spread across heterogeneous devices, additional data movements may be paired with choice of which accelerator is system-level optimal for portions of the computational task.

In general, a compute kernel may be a portion of a computer program that is offloaded to a computing device. In other words, a compute kernel may be a computational routine that is compiled for a computing device, such as an accelerator card. Accordingly, the one or more computing devices may be accelerator cards or computing offloading cards (e.g., XPUs), such as a Graphics Processing Unit (GPU), a Field-Programmable Gate Array (FPGA), and an Application-Specific Integrated Circuit (ASIC), such as an Artificial Intelligence (AI) accelerator or a communication processing offloading unit. For example, the one or more computing devices may exclude a CPU (Central Processing Unit) of the respective computer system.

In the present context, the pipelining of the data transfers may refer to a temporal staggering of at least one of the data transfers or of portions of the data transfers. In particular, the data transferred may be temporally staggered such, that at least a portion of one of the data transfers coincides with the execution of at least one of the compute kernels.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information. For example, the interface circuitry may be configured to communicate via at least one of PCIe, CXL, InfiniBand and Ethernet.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a workstation computer system (e.g., a workstation computer system being used for scientific computation) or a server computer system, i.e., a computer system being used to serve functionality, such as the computer program, to one or client computers.

More details and aspects of the computer system, apparatus, device, method, and corresponding computer program are mentioned in connection with the proposed concept, or one or more examples described above or below (e.g., FIGS. 2 to 5). The computer system, apparatus, device, method, and corresponding computer program may comprise one or more additional optional features corresponding to one or more aspects of the proposed concept, or one or more examples described above or below.

FIG. 2 shows a block diagram of an example of two computer systems 100 and 200, with one (100) of the computer systems comprising an apparatus 10 or device 10 (as shown in connection with FIGS. 1a and 1b) for scheduling an execution of compute kernels on one or more computing devices 105; 205, and at least the other computer system comprising one or more computing devices 105; 205. For example, both computer systems 100; 200 may comprise the one or more computing devices 105; 205, or only the second computer system 200 may comprise the one or more computing devices 205. An example, where only computer system 100 comprises the computing devices is shown in FIG. 1b.

More details and aspects of the computer system and apparatus or device are mentioned in connection with the proposed concept, or one or more examples described above or below (e.g., FIGS. 2 to 5). The computer system and apparatus, device may comprise one or more additional optional features corresponding to one or more aspects of the proposed concept, or one or more examples described above or below.

FIG. 3 shows an example of a scheduling of two kernels k₁, k₂ and associated data transfers, between a host 310 (e.g., the processing circuitry 14 of the computer system) and a device 320 (e.g., a computing device). Kernels k₁ and k₂ on tiles of the device 320, with kernels k₁ and k₂ depending on input data buffers A₁ and A₂, respectively, and generating output data B₁ and B₂, respectively. FIG. 3 shows the first possible ordering 330, where A₁ and A₂ share link bandwidth, leading to longer transfer times versus a single transfer utilizing the full link bandwidth. FIG. 3 further shows the second possible ordering 340 that is pipelined. In the second possible ordering 340, prioritizing one tile's execution leads to more bandwidth of the bus being available, an earlier start of kernel k₁, a reduction of system latency and faster overall execution through natural staggering of subsequent transfers.

FIG. 4 shows an example of a scheduling of pipelining of data transfers associated with a single kernel, between a host 410 (e.g., the processing circuitry of the computer system 100) and a device 420 (e.g., one of the one or more computing devices 105; 205).

FIG. 4 shows a first possible ordering 430, where, first input data buffer A is transferred, then, after A is finished, the kernel k is executed, and then the output data B is transmitted.

FIG. 4 further shows a second possible ordering 440. Here, kernel k is executed before input data buffer A is completely transferred, and the transfer of output data B starts before the execution of the kernel has finished. At the dashed line, input data buffer A has finished transfer and is no longer utilizing the transfer bus. If part of output data buffer B is functionally available for output transfer, it can begin to use the transfer bus bandwidth even if the kernel k has not completed, through the described improvements or optimizations. Decomposing the compute to a sub-kernel granularity can in some cases enable automatic overlapping of the input data transfer (of input data A), kernel invocation (or kernel k), and output data transfer (of output B), improved, or optimized for latency minimization or throughput maximization while increasing interconnect/memory efficiency.

FIG. 4 further shows a third possible ordering 450, which gives an example for pipelining with chunking denoted by subscripts, i.e. A₁ . . . A_{N}, B₁ . . . B_{M}. Threshold points defining the kernel's use of input data and generation of output data may enable overlap of kernel execution with transfer of the kernel's input and output data. A data transfer may overlap in time with other data transfers, or not, based on bus bandwidth improvement or optimization.

More details and aspects of the kernel scheduling and pipelining are mentioned in connection with the proposed concept, or one or more examples described above or below (e.g., FIG. 1a to 2). The kernel scheduling and pipelining may comprise one or more additional optional features corresponding to one or more aspects of the proposed concept, or one or more examples described above or below.

In the following, some examples of the present disclosure are presented:

An example (e.g., example 1) relates to an apparatus (10) for scheduling an execution of compute kernels on one or more computing devices (105, 205), the apparatus comprising processing circuitry (14) and interface circuitry (12), the processing circuitry being configured to determine an impending execution of two or more compute kernels to the one or more computing devices. The processing circuitry is configured to pipeline a data transfer related to the execution of the two or more compute kernels to the one or more computing devices via the interface circuitry.

Another example (e.g., example 2) relates to a previously described example (e.g., example 1) or to any of the examples described herein, further comprising that the data transfer is pipelined with the objective of reducing a time to execution of at least one of the two or more compute kernels.

Another example (e.g., example 3) relates to a previously described example (e.g., one of the examples 1 to 2) or to any of the examples described herein, further comprising that the data transfer is pipelined with the objective of reducing a power consumption or reducing a thermal impact of the execution of the two or more compute kernels or the data transfer.

Another example (e.g., example 4) relates to a previously described example (e.g., one of the examples 1 to 3) or to any of the examples described herein, further comprising that the data transfer is pipelined with the objective of balancing or increasing a utilization of the computing devices.

Another example (e.g., example 5) relates to a previously described example (e.g., one of the examples 1 to 4) or to any of the examples described herein, further comprising that the data transfer is pipelined with the objective of increasing a data processing throughput of the two or more compute kernels.

Another example (e.g., example 6) relates to a previously described example (e.g., one of the examples 1 to 5) or to any of the examples described herein, further comprising that the processing circuitry is configured to pipeline the data transfer to the one or more computing devices such, that a concurrent data transfer of data related to the two or more compute kernels is avoided.

Another example (e.g., example 7) relates to a previously described example (e.g., one of the examples 1 to 6) or to any of the examples described herein, further comprising that the data is to be transferred via the same communication link.

Another example (e.g., example 8) relates to a previously described example (e.g., one of the examples 1 to 7) or to any of the examples described herein, further comprising that the execution of the two or more compute kernels depends on the data transfer, wherein the processing circuitry is configured to pipeline the data transfer such, that the execution of at least one second of the two or more compute kernels and associated data is delayed until at least a portion of the data transfer related to a first compute kernel required for starting execution of the first compute kernel is completed.

Another example (e.g., example 9) relates to a previously described example (e.g., one of the examples 1 to 8) or to any of the examples described herein, further comprising that the processing circuitry is configured to determine, at least for a first compute kernel, a first portion of the data transfer required for starting execution of the first compute kernel and a second portion of the data transfer used after the execution of the first compute kernel is started, and to pipeline the data transfer such, that the data transfer related to at least one second compute kernel is delayed until the data transfer of the first portion is completed.

Another example (e.g., example 10) relates to a previously described example (e.g., example 9) or to any of the examples described herein, further comprising that the processing circuitry is configured to determine the first and second portion of the data transfer by performing static compiler analysis of the compute kernel.

Another example (e.g., example 11) relates to a previously described example (e.g., example 10) or to any of the examples described herein, further comprising that the static compiler analysis relates to memory access patterns.

Another example (e.g., example 12) relates to a previously described example (e.g., one of the examples 10 to 11) or to any of the examples described herein, further comprising that the static compiler analysis relates to a processing capability of the one or more computing devices the compute kernel is being compiled for.

Another example (e.g., example 13) relates to a previously described example (e.g., one of the examples 1 to 12) or to any of the examples described herein, further comprising that the processing circuitry is configured to emulate the execution of the compute kernel, and to determine the first and second portion based on memory accesses occurring during the emulation.

Another example (e.g., example 14) relates to a previously described example (e.g., one of the examples 1 to 13) or to any of the examples described herein, further comprising that the processing circuitry is configured to determine the first and second portion based on a monitoring of a prior execution of the respective compute kernel by the one or more computing devices.

Another example (e.g., example 15) relates to a previously described example (e.g., one of the examples 1 to 14) or to any of the examples described herein, further comprising that the processing circuitry is configured to determine the first and second portion based on user-specified information on the use of the data.

Another example (e.g., example 16) relates to a previously described example (e.g., one of the examples 1 to 15) or to any of the examples described herein, further comprising that the processing circuitry is configured to determine the first and second portion using heuristics regarding the location of the first portion within the data transfer.

Another example (e.g., example 17) relates to a previously described example (e.g., one of the examples 1 to 16) or to any of the examples described herein, further comprising that the processing circuitry is configured to pipeline the data transfer such, that the first portion of the data transfer related to the second compute kernel is started before the data transfer of the second portion of the data transfer related to the first compute kernel is started.

Another example (e.g., example 18) relates to a previously described example (e.g., one of the examples 1 to 17) or to any of the examples described herein, further comprising that the processing circuitry is configured to pipeline the data transfer based on a data communication bandwidth available for transferring the two or more compute kernels.

Another example (e.g., example 19) relates to a previously described example (e.g., one of the examples 1 to 18) or to any of the examples described herein, further comprising that the processing circuitry is configured to split an initial compute kernel to generate the two or more compute kernels.

Another example (e.g., example 20) relates to a previously described example (e.g., example 19) or to any of the examples described herein, further comprising that the processing circuitry is configured to determine the impending execution of the two or more compute kernels based on a user-specified invocation of the initial compute kernel.

Another example (e.g., example 21) relates to a previously described example (e.g., one of the examples 1 to 20) or to any of the examples described herein, further comprising that the processing circuitry is configured to determine the impending execution of the two or more compute kernels to the one or more computing devices based on a user-specified invocation of the two or more compute kernels.

Another example (e.g., example 22) relates to a previously described example (e.g., one of the examples 1 to 21) or to any of the examples described herein, further comprising that the processing circuitry is configured to provide a runtime environment for executing the two or more compute kernels using the one or more computing devices, with the runtime environment performing the determination of the impending execution and the pipelining of the data transfer.

Another example (e.g., example 23) relates to a previously described example (e.g., one of the examples 1 to 22) or to any of the examples described herein, further comprising that the processing circuitry is configured to host a driver for accessing the one or more computing devices, with the driver performing the determination of the impending execution and the pipelining of the data transfer.

Another example (e.g., example 24) relates to a previously described example (e.g., one of the examples 1 to 23) or to any of the examples described herein, further comprising that the processing circuitry is configured to compile a computer program comprising the two or more compute kernels, with the compilation being based on the pipelining of the data transfer.

Another example (e.g., example 25) relates to a previously described example (e.g., one of the examples 1 to 24) or to any of the examples described herein, further comprising that the processing circuitry is configured to use a hardware queuing mechanism of a computer system hosting the apparatus to pipeline the data transfer.

Another example (e.g., example 26) relates to a previously described example (e.g., one of the examples 1 to 25) or to any of the examples described herein, further comprising that the processing circuitry is configured to determine the impending execution of the two or more compute kernels to a single computing device, so that the two or more compute kernels are executed by the single computing device, and to pipeline the data transfer of the two or more compute kernels to the single computing device.

Another example (e.g., example 27) relates to a previously described example (e.g., one of the examples 1 to 25) or to any of the examples described herein, further comprising that the processing circuitry is configured to determine the impending execution of the two or more compute kernels to two or more computing devices of a single computer system, so that the two or more compute kernels are executed by the two or more computing devices, and to pipeline the data transfer of the two or more compute kernels to the two or more computing devices.

Another example (e.g., example 28) relates to a previously described example (e.g., one of the examples 1 to 25) or to any of the examples described herein, further comprising that the processing circuitry is configured to determine the impending execution of the two or more compute kernels to two or more computing devices of two or more computer systems, so that the two or more compute kernels are executed by the two or more computing devices, and to pipeline the data transfer of the two or more compute kernels to the two or more computing devices.

Another example (e.g., example 29) relates to a previously described example (e.g., one of the examples 1 to 28) or to any of the examples described herein, further comprising that the processing circuitry is configured to assign the two or more compute kernels to respective compute circuitry of the one or more computing devices, and to pipeline the data transfer of the two or more compute kernels to the respective computing device based on the assignment.

Another example (e.g., example 30) relates to a previously described example (e.g., example 29) or to any of the examples described herein, further comprising that the assignment is performed based on at least one of a constraint with respect to a time to execution, a throughput constraint, a utilization constraint, a power consumption constraint, and a thermal constraint.

Another example (e.g., example 31) relates to a previously described example (e.g., one of the examples 1 to 30) or to any of the examples described herein, further comprising that the processing circuitry is configured to adapt at least one of a capability of at least one interconnect and a capability of at least one memory system being involved in the execution and/or data transfer based on the pipelined data transfer.

An example (e.g., example 32) relates to a computer system (100) comprising the apparatus (10) according to one of the examples 1 to 31 and one or more computing devices (105).

An example (e.g., example 33) relates to a device (10) for scheduling an execution of compute kernels on one or more computing devices (105, 205), the device comprising means for processing (14) and means for communicating (12), the means for processing being configured to determine an impending execution of two or more compute kernels to the one or more computing devices. The means for processing is configured to pipeline a data transfer related to the execution of the two or more compute kernels to the one or more computing devices via the means for communicating.

Another example (e.g., example 34) relates to a previously described example (e.g., example 33) or to any of the examples described herein, further comprising that the data transfer is pipelined with the objective of reducing a time to execution of at least one of the two or more compute kernels.

Another example (e.g., example 35) relates to a previously described example (e.g., one of the examples 33 to 34) or to any of the examples described herein, further comprising that the data transfer is pipelined with the objective of reducing a power consumption or reducing a thermal impact of the execution of the two or more compute kernels or the data transfer.

Another example (e.g., example 36) relates to a previously described example (e.g., one of the examples 33 to 35) or to any of the examples described herein, further comprising that the data transfer is pipelined with the objective of balancing or increasing a utilization of the computing devices.

Another example (e.g., example 37) relates to a previously described example (e.g., one of the examples 33 to 37) or to any of the examples described herein, further comprising that the data transfer is pipelined with the objective of increasing a data processing throughput of the two or more compute kernels.

Another example (e.g., example 38) relates to a previously described example (e.g., one of the examples 33 to 37) or to any of the examples described herein, further comprising that the means for processing is configured to pipeline the data transfer to the one or more computing devices such, that a concurrent data transfer of data related to the two or more compute kernels is avoided.

Another example (e.g., example 39) relates to a previously described example (e.g., one of the examples 33 to 38) or to any of the examples described herein, further comprising that the data is to be transferred via the same communication link.

Another example (e.g., example 40) relates to a previously described example (e.g., one of the examples 33 to 39) or to any of the examples described herein, further comprising that the execution of the two or more compute kernels depends on the data transfer, wherein the means for processing is configured to pipeline the data transfer such, that the execution of at least one second of the two or more compute kernels and associated data is delayed until at least a portion of the data transfer related to a first compute kernel required for starting execution of the first compute kernel is completed.

Another example (e.g., example 41) relates to a previously described example (e.g., one of the examples 33 to 40) or to any of the examples described herein, further comprising that the means for processing is configured to determine, at least for a first compute kernel, a first portion of the data transfer required for starting execution of the first compute kernel and a second portion of the data transfer used after the execution of the first compute kernel is started, and to pipeline the data transfer such, that the data transfer related to at least one second compute kernel is delayed until the data transfer of the first portion is completed.

Another example (e.g., example 42) relates to a previously described example (e.g., example 41) or to any of the examples described herein, further comprising that the means for processing is configured to determine the first and second portion of the data transfer by performing static compiler analysis of the compute kernel.

Another example (e.g., example 43) relates to a previously described example (e.g., example 42) or to any of the examples described herein, further comprising that the static compiler analysis relates to memory access patterns.

Another example (e.g., example 44) relates to a previously described example (e.g., one of the examples 42 to 43) or to any of the examples described herein, further comprising that the static compiler analysis relates to a processing capability of the one or more computing devices the compute kernel is being compiled for.

Another example (e.g., example 45) relates to a previously described example (e.g., one of the examples 33 to 44) or to any of the examples described herein, further comprising that the means for processing is configured to emulate the execution of the compute kernel, and to determine the first and second portion based on memory accesses occurring during the emulation.

Another example (e.g., example 46) relates to a previously described example (e.g., one of the examples 33 to 45) or to any of the examples described herein, further comprising that the means for processing is configured to determine the first and second portion based on a monitoring of a prior execution of the respective compute kernel by the one or more computing devices.

Another example (e.g., example 47) relates to a previously described example (e.g., one of the examples 33 to 46) or to any of the examples described herein, further comprising that the means for processing is configured to determine the first and second portion based on user-specified information on the use of the data.

Another example (e.g., example 48) relates to a previously described example (e.g., one of the examples 33 to 47) or to any of the examples described herein, further comprising that the means for processing is configured to determine the first and second portion using heuristics regarding the location of the first portion within the data transfer.

Another example (e.g., example 49) relates to a previously described example (e.g., one of the examples 33 to 48) or to any of the examples described herein, further comprising that the means for processing is configured to pipeline the data transfer such, that the first portion of the data transfer related to the second compute kernel is started before the data transfer of the second portion of the data transfer related to the first compute kernel is started.

Another example (e.g., example 50) relates to a previously described example (e.g., one of the examples 33 to 49) or to any of the examples described herein, further comprising that the means for processing is configured to pipeline the data transfer based on a data communication bandwidth available for transferring the two or more compute kernels.

Another example (e.g., example 51) relates to a previously described example (e.g., one of the examples 33 to 50) or to any of the examples described herein, further comprising that the means for processing is configured to split an initial compute kernel to generate the two or more compute kernels.

Another example (e.g., example 52) relates to a previously described example (e.g., example 51) or to any of the examples described herein, further comprising that the means for processing is configured to determine the impending execution of the two or more compute kernels based on a user-specified invocation of the initial compute kernel.

Another example (e.g., example 53) relates to a previously described example (e.g., one of the examples 33 to 52) or to any of the examples described herein, further comprising that the means for processing is configured to determine the impending execution of the two or more compute kernels to the one or more computing devices based on a user-specified invocation of the two or more compute kernels.

Another example (e.g., example 54) relates to a previously described example (e.g., one of the examples 33 to 53) or to any of the examples described herein, further comprising that the means for processing is configured to provide a runtime environment for executing the two or more compute kernels using the one or more computing devices, with the runtime environment performing the determination of the impending execution and the pipelining of the data transfer.

Another example (e.g., example 55) relates to a previously described example (e.g., one of the examples 33 to 54) or to any of the examples described herein, further comprising that the means for processing is configured to host a driver for accessing the one or more computing devices, with the driver performing the determination of the impending execution and the pipelining of the data transfer.

Another example (e.g., example 56) relates to a previously described example (e.g., one of the examples 33 to 55) or to any of the examples described herein, further comprising that the means for processing is configured to compile a computer program comprising the two or more compute kernels, with the compilation being based on the pipelining of the data transfer.

Another example (e.g., example 57) relates to a previously described example (e.g., one of the examples 33 to 56) or to any of the examples described herein, further comprising that the means for processing is configured to use a hardware queuing mechanism of a computer system hosting the device to pipeline the data transfer.

Another example (e.g., example 58) relates to a previously described example (e.g., one of the examples 33 to 57) or to any of the examples described herein, further comprising that the means for processing is configured to determine the impending execution of the two or more compute kernels to a single computing device, so that the two or more compute kernels are executed by the single computing device, and to pipeline the data transfer of the two or more compute kernels to the single computing device.

Another example (e.g., example 59) relates to a previously described example (e.g., one of the examples 33 to 57) or to any of the examples described herein, further comprising that the means for processing is configured to determine the impending execution of the two or more compute kernels to two or more computing devices of a single computer system, so that the two or more compute kernels are executed by the two or more computing devices, and to pipeline the data transfer of the two or more compute kernels to the two or more computing devices.

Another example (e.g., example 60) relates to a previously described example (e.g., one of the examples 33 to 57) or to any of the examples described herein, further comprising that the means for processing is configured to determine the impending execution of the two or more compute kernels to two or more computing devices of two or more computer systems, so that the two or more compute kernels are executed by the two or more computing devices, and to pipeline the data transfer of the two or more compute kernels to the two or more computing devices.

Another example (e.g., example 61) relates to a previously described example (e.g., one of the examples 33 to 60) or to any of the examples described herein, further comprising that the means for processing is configured to assign the two or more compute kernels to respective means for computing of the one or more computing devices, and to pipeline the data transfer of the two or more compute kernels to the respective computing device based on the assignment.

Another example (e.g., example 62) relates to a previously described example (e.g., example 61) or to any of the examples described herein, further comprising that the assignment is performed based on at least one of a constraint with respect to a time to execution, a throughput constraint, a utilization constraint, a power consumption constraint, and a thermal constraint.

Another example (e.g., example 63) relates to a previously described example (e.g., one of the examples 33 to 62) or to any of the examples described herein, further comprising that the means for processing is configured to adapt at least one of a capability of at least one interconnect and a capability of at least one memory system being involved in the execution and/or data transfer based on the pipelined data transfer.

An example (e.g., example 64) relates to a computer system (100) comprising the device (10) according to one of the examples 33 to 63 and one or more computing devices (105).

An example (e.g., example 65) relates to a method for scheduling an execution of compute kernels on one or more computing devices (105, 205), the method comprising determining (110) an impending execution of two or more compute kernels to the one or more computing devices. The method (10) comprises pipelining (170) a data transfer related to the execution of the two or more compute kernels to the one or more computing devices.

Another example (e.g., example 66) relates to a previously described example (e.g., example 65) or to any of the examples described herein, further comprising that the data transfer is pipelined with the objective of reducing a time to execution of at least one of the two or more compute kernels.

Another example (e.g., example 67) relates to a previously described example (e.g., one of the examples 65 to 66) or to any of the examples described herein, further comprising that the data transfer is pipelined with the objective of reducing a power consumption or reducing a thermal impact of the execution of the two or more compute kernels or the data transfer.

Another example (e.g., example 68) relates to a previously described example (e.g., one of the examples 65 to 67) or to any of the examples described herein, further comprising that the data transfer is pipelined with the objective of balancing or increasing a utilization of the computing devices.

Another example (e.g., example 69) relates to a previously described example (e.g., one of the examples 65 to 68) or to any of the examples described herein, further comprising that the data transfer is pipelined with the objective of increasing a data processing throughput of the two or more compute kernels.

Another example (e.g., example 70) relates to a previously described example (e.g., one of the examples 65 to 69) or to any of the examples described herein, further comprising that the data transfer to the one or more computing devices is pipelined such, that a concurrent data transfer of data related to the two or more compute kernels is avoided.

Another example (e.g., example 71) relates to a previously described example (e.g., one of the examples 65 to 70) or to any of the examples described herein, further comprising that the data is to be transferred via the same communication link.

Another example (e.g., example 72) relates to a previously described example (e.g., one of the examples 65 to 71) or to any of the examples described herein, further comprising that the execution of the two or more compute kernels depends on the data transfer, wherein the data transfer is pipelined such, that the execution of at least one second of the two or more compute kernels and associated data is delayed until at least a portion of the data transfer related to a first compute kernel required for starting execution of the first compute kernel is completed.

Another example (e.g., example 73) relates to a previously described example (e.g., one of the examples 65 to 72) or to any of the examples described herein, further comprising that the method comprises determining (120), at least for a first compute kernel, a first portion of the data transfer required for starting execution of the first compute kernel and a second portion of the data transfer used after the execution of the first compute kernel is started, the data transfer being pipelined such, that the data transfer related to at least one second compute kernel is delayed until the data transfer of the first portion is completed.

Another example (e.g., example 74) relates to a previously described example (e.g., example 73) or to any of the examples described herein, further comprising that the method comprises determining (120) the first and second portion of the data transfer by performing (122) static compiler analysis of the compute kernel.

Another example (e.g., example 75) relates to a previously described example (e.g., example 74) or to any of the examples described herein, further comprising that the static compiler analysis relates to memory access patterns.

Another example (e.g., example 76) relates to a previously described example (e.g., one of the examples 74 to 75) or to any of the examples described herein, further comprising that the static compiler analysis relates to a processing capability of the one or more computing devices the compute kernel is being compiled for.

Another example (e.g., example 77) relates to a previously described example (e.g., one of the examples 65 to 76) or to any of the examples described herein, further comprising that the method comprises emulating (124) the execution of the compute kernel and determining (120) the first and second portion based on memory accesses occurring during the emulation.

Another example (e.g., example 78) relates to a previously described example (e.g., one of the examples 65 to 77) or to any of the examples described herein, further comprising that the method comprises determining (120) the first and second portion based on a monitoring (126) of a prior execution of the respective compute kernel by the one or more computing devices.

Another example (e.g., example 79) relates to a previously described example (e.g., one of the examples 65 to 78) or to any of the examples described herein, further comprising that the method comprises determining (120) the first and second portion based on user-specified information on the use of the data.

Another example (e.g., example 80) relates to a previously described example (e.g., one of the examples 65 to 79) or to any of the examples described herein, further comprising that the method comprises determining (120) the first and second portion using heuristics regarding the location of the first portion within the data transfer.

Another example (e.g., example 81) relates to a previously described example (e.g., one of the examples 65 to 80) or to any of the examples described herein, further comprising that the data transfer is pipelined such, that the first portion of the data transfer related to the second compute kernel is started before the data transfer of the second portion of the data transfer related to the first compute kernel is started.

Another example (e.g., example 82) relates to a previously described example (e.g., one of the examples 65 to 81) or to any of the examples described herein, further comprising that the data transfer is pipelined based on a data communication bandwidth available for transferring the two or more compute kernels.

Another example (e.g., example 83) relates to a previously described example (e.g., one of the examples 65 to 82) or to any of the examples described herein, further comprising that the method comprises splitting (140) an initial compute kernel to generate the two or more compute kernels.

Another example (e.g., example 84) relates to a previously described example (e.g., example 83) or to any of the examples described herein, further comprising that the impending execution of the two or more compute kernels is determined based on a user-specified invocation of the initial compute kernel.

Another example (e.g., example 85) relates to a previously described example (e.g., one of the examples 65 to 84) or to any of the examples described herein, further comprising that the impending execution of the two or more compute kernels to the one or more computing devices is determined based on a user-specified invocation of the two or more compute kernels.

Another example (e.g., example 86) relates to a previously described example (e.g., one of the examples 65 to 85) or to any of the examples described herein, further comprising that a runtime environment performs the determination of the impending execution and the pipelining of the data transfer.

Another example (e.g., example 87) relates to a previously described example (e.g., one of the examples 65 to 86) or to any of the examples described herein, further comprising that a driver performs the determination of the impending execution and the pipelining of the data transfer.

Another example (e.g., example 88) relates to a previously described example (e.g., one of the examples 65 to 87) or to any of the examples described herein, further comprising that the method comprises compiling (150) a computer program comprising the two or more compute kernels, with the compilation being based on the pipelining of the data transfer.

Another example (e.g., example 89) relates to a previously described example (e.g., one of the examples 65 to 88) or to any of the examples described herein, further comprising that a hardware queuing mechanism of a computer system performing the method is used to pipeline the data transfer.

Another example (e.g., example 90) relates to a previously described example (e.g., one of the examples 65 to 89) or to any of the examples described herein, further comprising that the method comprises determining the impending execution of the two or more compute kernels to a single computing device, so that the two or more compute kernels are executed by the single computing device, and to pipeline the data transfer of the two or more compute kernels to the single computing device.

Another example (e.g., example 91) relates to a previously described example (e.g., one of the examples 65 to 89) or to any of the examples described herein, further comprising that the method comprises determining the impending execution of the two or more compute kernels to two or more computing devices of a single computer system, so that the two or more compute kernels are executed by the two or more computing devices, and to pipeline the data transfer of the two or more compute kernels to the two or more computing devices.

Another example (e.g., example 92) relates to a previously described example (e.g., one of the examples 65 to 89) or to any of the examples described herein, further comprising that the method comprises determining the impending execution of the two or more compute kernels to two or more computing devices of two or more computer systems, so that the two or more compute kernels are executed by the two or more computing devices, and to pipeline the data transfer of the two or more compute kernels to the two or more computing devices.

Another example (e.g., example 93) relates to a previously described example (e.g., one of the examples 65 to 92) or to any of the examples described herein, further comprising that the method comprises assigning (130) the two or more compute kernels to respective compute circuitry of the one or more computing devices and pipelining the data transfer of the two or more compute kernels to the respective computing device based on the assignment.

Another example (e.g., example 94) relates to a previously described example (e.g., example 93) or to any of the examples described herein, further comprising that the assignment is performed based on at least one of a constraint with respect to a time to execution, a throughput constraint, a utilization constraint, a power consumption constraint, and a thermal constraint.

Another example (e.g., example 95) relates to a previously described example (e.g., one of the examples 65 to 94) or to any of the examples described herein, further comprising that the method comprises adapting (160) at least one of a capability of at least one interconnect and a capability of at least one memory system being involved in the execution and/or data transfer based on the pipelined data transfer.

An example (e.g., example 96) relates to a computer system (100) comprising one or more computing devices (105), the computer system being configured to perform the method the according to one of the examples 65 to 95.

An example (e.g., example 97) relates to a non-transitory machine-readable storage medium including program code, when executed, to cause a machine to perform the method of one of the examples 65 to 95.

An example (e.g., example 98) relates to a computer program having a program code for performing the method of one of the examples 65 to 95 when the computer program is executed on a computer, a processor, or a programmable hardware component.

An example (e.g., example 99) relates to a machine-readable storage including machine readable instructions, when executed, to implement a method or realize an apparatus as claimed in any pending claim or shown in any example.

An example (e.g., example 100) relates to an apparatus (10) for scheduling an execution of compute kernels on one or more computing devices (105, 205), the apparatus comprising interface circuitry, machine-readable instructions and processing circuitry (14) to execute the machine-readable instructions to determine an impending execution of two or more compute kernels to the one or more computing devices. The machine-readable instructions comprise instructions to pipeline a data transfer related to the execution of the two or more compute kernels to the one or more computing devices via the interface circuitry.

Another example (e.g., example 101) relates to a previously described example (e.g., example 100) or to any of the examples described herein, further comprising that the data transfer is pipelined with the objective of reducing a time to execution of at least one of the two or more compute kernels.

Another example (e.g., example 102) relates to a previously described example (e.g., one of the examples 100 to 101) or to any of the examples described herein, further comprising that the data transfer is pipelined with the objective of reducing a power consumption or reducing a thermal impact of the execution of the two or more compute kernels or the data transfer.

Another example (e.g., example 103) relates to a previously described example (e.g., one of the examples 100 to 102) or to any of the examples described herein, further comprising that the data transfer is pipelined with the objective of balancing or increasing a utilization of the computing devices.

Another example (e.g., example 104) relates to a previously described example (e.g., one of the examples 100 to 103) or to any of the examples described herein, further comprising that the data transfer is pipelined with the objective of increasing a data processing throughput of the two or more compute kernels.

Another example (e.g., example 105) relates to a previously described example (e.g., one of the examples 100 to 104) or to any of the examples described herein, further comprising that the machine-readable instructions comprise instructions to pipeline the data transfer to the one or more computing devices such, that a concurrent data transfer of data related to the two or more compute kernels is avoided.

Another example (e.g., example 106) relates to a previously described example (e.g., one of the examples 100 to 105) or to any of the examples described herein, further comprising that the data is to be transferred via the same communication link.

Another example (e.g., example 107) relates to a previously described example (e.g., one of the examples 100 to 106) or to any of the examples described herein, further comprising that the execution of the two or more compute kernels depends on the data transfer, wherein the machine-readable instructions comprise instructions to pipeline the data transfer such, that the execution of at least one second of the two or more compute kernels and associated data is delayed until at least a portion of the data transfer related to a first compute kernel required for starting execution of the first compute kernel is completed.

Another example (e.g., example 108) relates to a previously described example (e.g., one of the examples 100 to 107) or to any of the examples described herein, further comprising that the machine-readable instructions comprise instructions to determine, at least for a first compute kernel, a first portion of the data transfer required for starting execution of the first compute kernel and a second portion of the data transfer used after the execution of the first compute kernel is started, and to pipeline the data transfer such, that the data transfer related to at least one second compute kernel is delayed until the data transfer of the first portion is completed.

Another example (e.g., example 109) relates to a previously described example (e.g., example 108) or to any of the examples described herein, further comprising that the machine-readable instructions comprise instructions to determine the first and second portion of the data transfer by performing static compiler analysis of the compute kernel.

Another example (e.g., example 110) relates to a previously described example (e.g., example 109) or to any of the examples described herein, further comprising that the static compiler analysis relates to memory access patterns.

Another example (e.g., example 111) relates to a previously described example (e.g., one of the examples 109 to 110) or to any of the examples described herein, further comprising that the static compiler analysis relates to a processing capability of the one or more computing devices the compute kernel is being compiled for.

Another example (e.g., example 112) relates to a previously described example (e.g., one of the examples 100 to 111) or to any of the examples described herein, further comprising that the machine-readable instructions comprise instructions to emulate the execution of the compute kernel, and to determine the first and second portion based on memory accesses occurring during the emulation.

Another example (e.g., example 113) relates to a previously described example (e.g., one of the examples 100 to 112) or to any of the examples described herein, further comprising that the machine-readable instructions comprise instructions to determine the first and second portion based on a monitoring of a prior execution of the respective compute kernel by the one or more computing devices.

Another example (e.g., example 114) relates to a previously described example (e.g., one of the examples 100 to 113) or to any of the examples described herein, further comprising that the machine-readable instructions comprise instructions to determine the first and second portion based on user-specified information on the use of the data.

Another example (e.g., example 115) relates to a previously described example (e.g., one of the examples 100 to 114) or to any of the examples described herein, further comprising that the machine-readable instructions comprise instructions to determine the first and second portion using heuristics regarding the location of the first portion within the data transfer.

Another example (e.g., example 116) relates to a previously described example (e.g., one of the examples 100 to 115) or to any of the examples described herein, further comprising that the machine-readable instructions comprise instructions to pipeline the data transfer such, that the first portion of the data transfer related to the second compute kernel is started before the data transfer of the second portion of the data transfer related to the first compute kernel is started.

Another example (e.g., example 117) relates to a previously described example (e.g., one of the examples 100 to 116) or to any of the examples described herein, further comprising that the machine-readable instructions comprise instructions to pipeline the data transfer based on a data communication bandwidth available for transferring the two or more compute kernels.

Another example (e.g., example 118) relates to a previously described example (e.g., one of the examples 100 to 117) or to any of the examples described herein, further comprising that the machine-readable instructions comprise instructions to split an initial compute kernel to generate the two or more compute kernels.

Another example (e.g., example 119) relates to a previously described example (e.g., example 118) or to any of the examples described herein, further comprising that the machine-readable instructions comprise instructions to determine the impending execution of the two or more compute kernels based on a user-specified invocation of the initial compute kernel.

Another example (e.g., example 120) relates to a previously described example (e.g., one of the examples 100 to 119) or to any of the examples described herein, further comprising that the machine-readable instructions comprise instructions to determine the impending execution of the two or more compute kernels to the one or more computing devices based on a user-specified invocation of the two or more compute kernels.

Another example (e.g., example 121) relates to a previously described example (e.g., one of the examples 100 to 120) or to any of the examples described herein, further comprising that the machine-readable instructions comprise instructions to provide a runtime environment for executing the two or more compute kernels using the one or more computing devices, with the runtime environment performing the determination of the impending execution and the pipelining of the data transfer.

Another example (e.g., example 122) relates to a previously described example (e.g., one of the examples 100 to 121) or to any of the examples described herein, further comprising that the machine-readable instructions comprise instructions to host a driver for accessing the one or more computing devices, with the driver performing the determination of the impending execution and the pipelining of the data transfer.

Another example (e.g., example 123) relates to a previously described example (e.g., one of the examples 100 to 122) or to any of the examples described herein, further comprising that the machine-readable instructions comprise instructions to compile a computer program comprising the two or more compute kernels, with the compilation being based on the pipelining of the data transfer.

Another example (e.g., example 124) relates to a previously described example (e.g., one of the examples 100 to 123) or to any of the examples described herein, further comprising that the machine-readable instructions comprise instructions to use a hardware queuing mechanism of a computer system hosting the apparatus to pipeline the data transfer.

Another example (e.g., example 125) relates to a previously described example (e.g., one of the examples 100 to 124) or to any of the examples described herein, further comprising that the machine-readable instructions comprise instructions to determine the impending execution of the two or more compute kernels to a single computing device, so that the two or more compute kernels are executed by the single computing device, and to pipeline the data transfer of the two or more compute kernels to the single computing device.

Another example (e.g., example 126) relates to a previously described example (e.g., one of the examples 100 to 125) or to any of the examples described herein, further comprising that the machine-readable instructions comprise instructions to determine the impending execution of the two or more compute kernels to two or more computing devices of a single computer system, so that the two or more compute kernels are executed by the two or more computing devices, and to pipeline the data transfer of the two or more compute kernels to the two or more computing devices.

Another example (e.g., example 127) relates to a previously described example (e.g., one of the examples 100 to 126) or to any of the examples described herein, further comprising that the machine-readable instructions comprise instructions to determine the impending execution of the two or more compute kernels to two or more computing devices of two or more computer systems, so that the two or more compute kernels are executed by the two or more computing devices, and to pipeline the data transfer of the two or more compute kernels to the two or more computing devices.

Another example (e.g., example 128) relates to a previously described example (e.g., one of the examples 100 to 127) or to any of the examples described herein, further comprising that the machine-readable instructions comprise instructions to assign the two or more compute kernels to respective compute circuitry of the one or more computing devices, and to pipeline the data transfer of the two or more compute kernels to the respective computing device based on the assignment.

Another example (e.g., example 129) relates to a previously described example (e.g., example 128) or to any of the examples described herein, further comprising that the assignment is performed based on at least one of a constraint with respect to a time to execution, a throughput constraint, a utilization constraint, a power consumption constraint, and a thermal constraint.

Another example (e.g., example 130) relates to a previously described example (e.g., one of the examples 100 to 129) or to any of the examples described herein, further comprising that the machine-readable instructions comprise instructions to adapt at least one of a capability of at least one interconnect and a capability of at least one memory system being involved in the execution and/or data transfer based on the pipelined data transfer.

An example (e.g., example 131) relates to a computer system (100) comprising the apparatus (10) according to one of the examples 100 to 130 and one or more computing devices (105).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for scheduling an execution of compute kernels on one or more computing devices, the apparatus comprising interface circuitry, machine-readable instructions and processing circuitry to execute the machine-readable instructions to:
determine an impending execution of two or more compute kernels to the one or more computing devices; and
pipeline a data transfer related to the execution of the two or more compute kernels to the one or more computing devices via the interface circuitry.

2. The apparatus according to claim 1, wherein the data transfer is pipelined with the objective of reducing a time to execution of at least one of the two or more compute kernels.

3. The apparatus according to claim 1, wherein the data transfer is pipelined with the objective of reducing a power consumption or reducing a thermal impact of the execution of the two or more compute kernels or the data transfer.

4. The apparatus according to claim 1, wherein the data transfer is pipelined with the objective of balancing or increasing a utilization of the computing devices.

5. The apparatus according to claim 1, wherein the data transfer is pipelined with the objective of increasing a data processing throughput of the two or more compute kernels.

6. The apparatus according to claim 1, wherein the machine-readable instructions comprise instructions to pipeline the data transfer to the one or more computing devices such, that a concurrent data transfer of data related to the two or more compute kernels is avoided.

7. The apparatus according to claim 1, wherein the execution of the two or more compute kernels depends on the data transfer, wherein the machine-readable instructions comprise instructions to pipeline the data transfer such, that the execution of at least one second of the two or more compute kernels and associated data is delayed until at least a portion of the data transfer related to a first compute kernel required for starting execution of the first compute kernel is completed.

8. The apparatus according to claim 1, wherein the machine-readable instructions comprise instructions to determine, at least for a first compute kernel, a first portion of the data transfer required for starting execution of the first compute kernel and a second portion of the data transfer used after the execution of the first compute kernel is started, and to pipeline the data transfer such, that the data transfer related to at least one second compute kernel is delayed until the data transfer of the first portion is completed.

9. The apparatus according to claim 8 wherein the machine-readable instructions comprise instructions to determine the first and second portion of the data transfer by performing static compiler analysis of the compute kernel.

10. The apparatus according to claim 1, wherein the machine-readable instructions comprise instructions to emulate the execution of the compute kernel, and to determine the first and second portion based on memory accesses occurring during the emulation.

11. The apparatus according to claim 1, wherein the machine-readable instructions comprise instructions to determine the first and second portion based on a monitoring of a prior execution of the respective compute kernel by the one or more computing devices.

12. The apparatus according to claim 1, wherein the machine-readable instructions comprise instructions to determine the first and second portion based on user-specified information on the use of the data.

13. The apparatus according to claim 1, wherein the machine-readable instructions comprise instructions to determine the first and second portion using heuristics regarding the location of the first portion within the data transfer.

14. The apparatus according to claim 1, wherein the machine-readable instructions comprise instructions to pipeline the data transfer such, that the first portion of the data transfer related to the second compute kernel is started before the data transfer of the second portion of the data transfer related to the first compute kernel is started.

15. The apparatus according to claim 1, wherein the machine-readable instructions comprise instructions to pipeline the data transfer based on a data communication bandwidth available for transferring the two or more compute kernels.

16. The apparatus according to claim 1, wherein the machine-readable instructions comprise instructions to split an initial compute kernel to generate the two or more compute kernels.

17. The apparatus according to claim 1, wherein the machine-readable instructions comprise instructions to provide a runtime environment for executing the two or more compute kernels using the one or more computing devices, with the runtime environment performing the determination of the impending execution and the pipelining of the data transfer.

18. The apparatus according to claim 1, wherein the machine-readable instructions comprise instructions to host a driver for accessing the one or more computing devices, with the driver performing the determination of the impending execution and the pipelining of the data transfer.

19. The apparatus according to claim 1, wherein the machine-readable instructions comprise instructions to compile a computer program comprising the two or more compute kernels, with the compilation being based on the pipelining of the data transfer.

20. The apparatus according to claim 1, wherein the machine-readable instructions comprise instructions to use a hardware queuing mechanism of a computer system hosting the apparatus to pipeline the data transfer.

21. The apparatus according to claim 1, wherein the machine-readable instructions comprise instructions to assign the two or more compute kernels to respective compute circuitry of the one or more computing devices, and to pipeline the data transfer of the two or more compute kernels to the respective computing device based on the assignment, with the assignment being performed based on at least one of a constraint with respect to a time to execution, a throughput constraint, a utilization constraint, a power consumption constraint, and a thermal constraint.

22. The apparatus according to claim 1, wherein the machine-readable instructions comprise instructions to adapt at least one of a capability of at least one interconnect and a capability of at least one memory system being involved in the execution and/or data transfer based on the pipelined data transfer.

23. A method for scheduling an execution of compute kernels on one or more computing devices, the method comprising:
determining an impending execution of two or more compute kernels to the one or more computing devices; and
pipelining a data transfer related to the execution of the two or more compute kernels to the one or more computing devices.

24. A non-transitory machine-readable storage medium including program code, when executed, to cause a machine to perform the method of claim 23.
